(19) United States
(12) Patent Application Publication
(10) Pub. No.: US 2021/0264218 A1
(43) Pub. Date: Aug. 26, 2021

(54) CHARACTER RECOGNITION SYSTEM AND METHOD

(71) Applicant: HITACHI, LTD., Tokyo (JP)

(72) Inventors: Ryosuke ODATE, Tokyo (JP); Terufumi MORISHITA, Tokyo (JP)

(73) Assignee: HITACHI, LTD., Tokyo (JP)

(21) Appl. No.: 17/002,302

(22) Filed: Aug. 25, 2020

(30) Foreign Application Priority Data
Feb. 25, 2020 (JP) 2020-029510

(51) Int. Cl. G06K 9/62; G06K 9/68; G06K 9/34

(52) U.S. Cl. CPC G06K 9/6263; G06K 9/344; G06K 9/6203; G06K 9/6878

(57) ABSTRACT

A character recognition system converting image data of a character string into a character code is provided, which includes a data processing unit, and a storage unit configured to be used by the data processing unit, wherein the storage unit stores similar-outline nonsense character string data that has an outline similar to that of to an ordinary character string but does not make sense, and the data processing unit performs character recognition processing using the similar-outline nonsense character string data that is stored in the storage unit.

### BACKGROUND

The present invention relates to a character recognition system and a method.

In recent years, due to the dissemination of character recognition technology, operation of converting document description content into electronic data has been automated through the utilization of character recognition processing.

In the conversion of the document description content into electronic data, a risk of erroneous conversion into electronic data caused by erroneous recognition of characters has to be reduced. In consideration thereof, only character strings that are readily recognized are automatically input while character strings that are difficult to recognize are presented to an operator to be entered as data by the operator.

In the prior art, character recognition processing is performed on a document, then, in accordance with a level of a certainty factor of recognition with respect to each character and each character string, subsequent processing is branched into automatic input and presentation to an operator. In this case, the certainty factor refers to a numerical value for predicting correctness of a character recognition result. As methods of calculating the certainty factor, the following two methods are mainstream methods. The first method involves using, as a certainty factor, a probability of assignment of a recognition target character to all character types which is generally calculated in character recognition processing. The other method involves performing text correction using linguistic knowledge with respect to a character recognition result thereby increasing or reducing a certainty factor in accordance with an amount of corrections.

A certainty factor does not necessarily accurately represent whether or not a character recognition result is correct. For example, in a case where the character “ [symbol] ” is to be recognized, calculating a certainty factor on the basis of assignments to all character types causes a high certainty factor to be output also with respect to similar characters such as “ [symbol] ” and “ [symbol] ” and may result in erroneous character recognition.

Therefore, when subjecting the document description content to character recognition and converting the description content into electronic data, in order to accurately and automatically input as many character strings as possible, it is important to improve accuracy of character recognition and to accurately perform branching into automatic input and presentation to an operator.

To this end, a method of reducing erroneous recognition of characters and increasing a correlation between a certainty factor of character recognition and whether a character recognition result is actually correct or incorrect has been studied (Japanese Patent Application Publication No. 2002-92016). Japanese Patent Application Publication No. 2002-92016 includes a description with the wording “An image search method including: storing a document image together with a character recognition result thereof; when searching the document image for an arbitrary designated character string by using the character recognition result, generating a new set of character strings by expanding the designated character string by referring to a database storing sets of characters that are likely to be misread in character recognition; selectably displaying, in character string units, each generated expanded character string as a search target character string candidate; and performing a character string search of the document image on the basis of a character string having been narrowed down by the selection and by the designated character string”.

Using the technique described in Japanese Patent Application Publication No. 2002-92016, in which sets of characters that are likely to be misread are stored in a database and the database is referred to during character recognition, it is possible to reduce recognition error. As a result, the correlation between a certainty factor and whether a character recognition result is correct or incorrect can be indirectly increased.

### SUMMARY

The prior art described in Japanese Patent Application Publication No. 2002-92016 enables, by reducing recognition error using a database of characters that are likely to be misread, the correlation between a certainty factor and whether a character recognition result is correct or incorrect to be indirectly increased. However, since the prior art described in Japanese Patent Application Publication No. 2002-92016 does not exactly introduce a novel certainty factor calculation method, there is a problem in that the correlation between a certainty factor and whether character recognition is correct or incorrect cannot be directly increased.

An object of the present disclosure is to provide a character recognition system and a method with high reliability.

In order to solve the problem described above, a character recognition system according to the present invention is a character recognition system that converts image data of a character string into a character code, the character recognition system including a data processing unit and a storage unit configured to be used by the data processing unit, wherein the storage unit is configured to store a similar-outline nonsense character string that has an outline similar to that of an ordinary character string but does not make sense, and the data processing unit is configured to perform character recognition processing using the similar-outline nonsense character string that is stored in the storage unit.

According to the present invention, character recognition processing can be performed using a similar-outline nonsense character string that has an outline similar to that of an ordinary character string but does not make sense.

### BRIEF DESCRIPTION OF THE DRAWINGS

FIG. 1 is a diagram showing a general outline of the present disclosure;

FIG. 2 is diagram showing hardware and software configurations of a character recognition system;

FIG. 3 is a flow chart showing character recognition processing;

FIG. 4 is a diagram showing an example of character recognition result data;

FIG. 5 is a diagram showing an example of a similar-outline nonsense character string (which can also be referred to as a linguistically incomplete character string);

FIG. 6 is a schematic diagram showing a result of character recognition processing and a result of certainty factor calculation processing;

FIG. 7 is a flow chart showing processing for collating a stored similar-outline nonsense character string with a character recognition result;

FIG. 8 is a flow chart showing certainty factor calculation processing;

FIG. 9 is a flow chart showing character string output processing and certainty factor output processing;

FIG. 10 is a diagram showing an example of a word corpus;

FIG. 11 is a diagram showing an example of similar character definition data;

FIG. 12 is a flow chart of processing for generating a candidate of a similar-outline nonsense character string;

FIG. 13 is a flow chart showing other processing for generating a candidate of a similar-outline nonsense character string;

FIG. 14 is a user interface screen that is provided by the character recognition system; and

FIG. 15 is a schematic diagram of a character recognition system according to a second embodiment.

### DETAILED DESCRIPTION OF THE EMBODIMENTS

Hereinafter, embodiments of the present invention will be described with reference to the drawings. In the present embodiments, as will be described later, a character recognition system is provided which realizes an improvement in accuracy of character recognition and a direct increase in a correlation between a certainty factor and whether character recognition is correct or incorrect.

A computer according an aspect of the present disclosure stores a character string that is readily misread and does not make linguistic sense (a similar-outline nonsense character string) in a database for the purposes of character recognition and certainty factor calculation, checks whether or not a character string that is a result of character recognition (a recognition result character string) is present in the database, and when the recognition result character string is present in the database, corrects the recognition result character string to a correct character string and, further, reduces a certainty factor related to the character recognition result character string on the grounds that the correction has been performed.

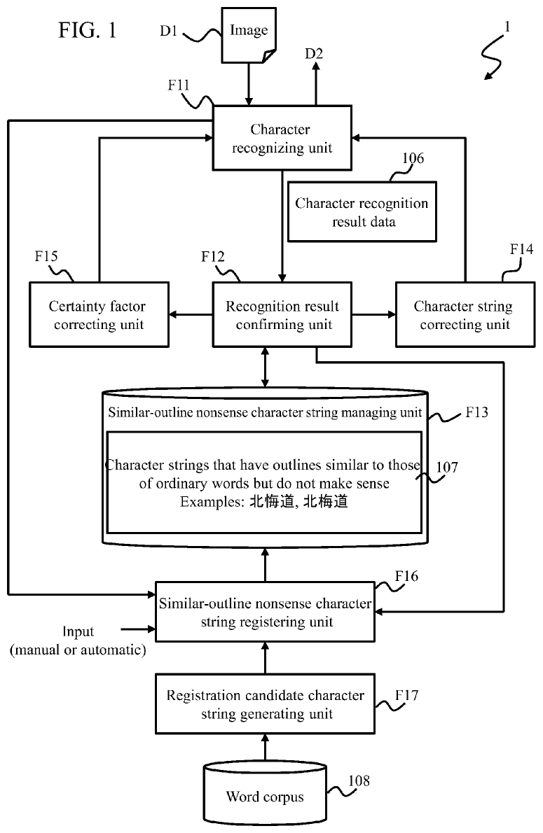

FIG. 1 shows a general outline of a character recognition system 1. All of the components shown in FIG. 1 need not be necessary in the present embodiments and the present embodiments can be constructed from a part of the components shown in FIG. 1. In addition, the present embodiments can also include components not shown in FIG. 1.

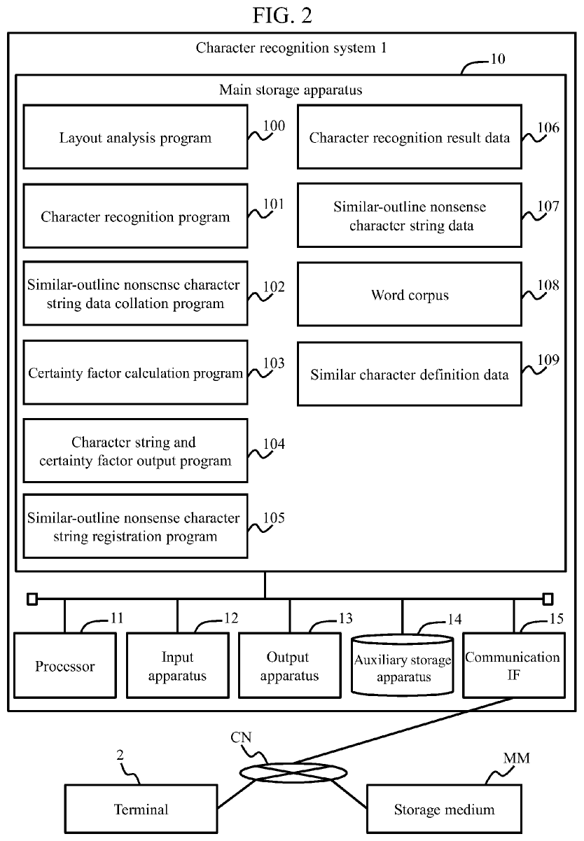

The character recognition system 1 can be constructed using one or a plurality of computers. A description will now be given with a focus on functionality of the character recognition system 1. A detailed configuration will be described with reference to FIG. 2 and thereafter.

For example, the character recognition system 1 can include a character recognizing unit F11, a recognition result confirming unit F12, a similar-outline nonsense character string managing unit F13, a character string correcting unit F14, a certainty factor correcting unit F15, a similar-outline nonsense character string registering unit F16, a registration candidate character string generating unit F17, and a word corpus 108. The word corpus 108 may be provided inside the character recognition system 1 or may be present outside thereof.

The character recognizing unit F11 performs character recognition processing. When image data D1 of a character string to be a target of character recognition processing is input, the character recognizing unit F11 subjects the image data D1 to image processing, converts the image data D1 into a character code, and outputs code data D2 of the character string. As will be described later, when converting the image data D1 into the code data D2 of the character string, a recognition result is inspected and the code data D2 of the character string is corrected and, at the same time, a certainty factor of character recognition processing is corrected.

The recognition result confirming unit F12 confirms whether the character string (a recognition result character string) having been subjected to character recognition by the character recognizing unit F11 is being managed by the similar-outline nonsense character string managing unit F13.

The similar-outline nonsense character string managing unit F13 is configured as, for example, a database and stores and manages similar-outline nonsense character string data 107. The similar-outline nonsense character string is stored in the managing unit F13 in association with a correct character string.

In this case, a similar-outline nonsense character string refers to a character string that has an outline similar to that of an ordinary character string but does not make sense. A similar-outline nonsense character string can be rephrased as a character string which is likely to be misread and which does not make linguistic sense. For example, image data of a character string that reads “ [symbol] ” may conceivably be erroneously converted into “ [symbol] ”. This is because “ [symbol] ” and “ [symbol] ” are characters with similar outlines and are readily mistaken for one another. In this case, the erroneously recognized “ [symbol] ” is a similar-outline nonsense character string that corresponds to “ [symbol] ” and is stored in the management unit F13.

An example of a definition of an ordinary character string is a character string which is used in a predetermined language (for example, Japanese) that is a target of character recognition processing and which has an entry in an ordinary dictionary or an ordinary word corpus. It should be noted that a technical term dictionary or a word corpus of technical terms that is used in a specific field may be used in place of the ordinary dictionary or the ordinary word corpus.

The character string correcting unit F14 corrects a recognition result character string to a correct character string when the recognition result character string corresponds to a similar-outline nonsense character string.

The certainty factor correcting unit F15 lowers a certainty factor of character recognition processing related to a recognition result character string when the recognition result character string corresponds to a similar-outline nonsense character string. This is because the character recognition is erroneous.

The similar-outline nonsense character string registering unit F16 causes the registration candidate character string generating unit F17 to generate a similar-outline nonsense character string and store the generated similar-outline nonsense character string in the similar-outline nonsense character string managing unit F13. The similar-outline nonsense character string registering unit F16 and the registration candidate character string generating unit F17 are examples of the “registration unit”.

For example, the registration candidate character string generating unit F17 can automatically generate a candidate of a similar-outline nonsense character string using an arbitrary word corpus 108 and input the generated candidate of a similar-outline nonsense character string to the similar-outline nonsense character string registering unit F16.

Specifically, as will be described later, the registration candidate character string generating unit F17 replaces one or a plurality of characters among an arbitrary character string of the word corpus 108 with a character with a similar outline, and when the character string after the replacement does not make sense, the registration candidate character string generating unit F17 adopts the character string as a candidate of a similar-outline nonsense character string.

Based on a result of erroneous character recognition processing by the character recognizing unit F11, the similar-outline nonsense character string registering unit F16 can select a candidate of a similar-outline nonsense character string and store the selected candidate in the similar-outline nonsense character string managing unit F13.

The similar-outline nonsense character string registering unit F16 can also cause a candidate of a similar-outline nonsense character string to be manually or automatically stored in the similar-outline nonsense character string managing unit F13.

According to the present disclosure that is configured as described above, since character recognition processing can be executed using a similar-outline nonsense character string, an improvement in accuracy of character recognition and a direct increase in a correlation between a certainty factor and whether character recognition is correct or incorrect can be realized.

### First Embodiment

A first embodiment will now be described with reference to FIGS. 2 to 14. As described above, in the present embodiment, processing is performed which involves storing a set of character strings that are readily misread and do not make linguistic sense (similar-outline nonsense character strings) in a database, referring to the database during character recognition, and when a character string that is included in the database is present in a recognition result, changing an output to a correct character string and, further, lowering a certainty factor.

Hereinafter, a character string that has an outline similar to that of an ordinary character string but does not make sense will be referred to as a similar-outline nonsense character string. In other words, a similar-outline nonsense character string is a character string which is likely to be misread and which does not make linguistic sense. Therefore, a similar-outline nonsense character string can also be referred to as a linguistically incomplete character string.

Hereinafter, redundant descriptions will be omitted. In addition, it is to be understood that the descriptions of embodiments are not intended to limit the invention as set forth in the accompanying claims. It should also be noted that all of the respective elements and combinations thereof described in the embodiments are not necessarily essential to solutions proposed by the invention.

In the following description, while expressions such as “xxx data” may be used as an example of information, information may adopt any kind of data structure. In other words, “xxx data” can be referred to as an “xxx table” in order to demonstrate that information is not dependent on data structure. In addition, in the following description, a configuration of each piece of information is merely an example and information may be retained by being divided into pieces or pieces of information may be retained by being combined into one.

FIG. 2 shows a hardware configuration and a software configuration of a computer that realizes the character recognition system 1. The character recognition system 1 can be provided in one physical computer or one virtual computer. The character recognition system 1 can also be realized by having a plurality of physical computers cooperate with one another or by having a plurality of virtual computers cooperate with one another.

As will be described later, the character recognition system 1 executes character recognition and certainty factor calculation processing. In addition, the character recognition system 1 also executes processing related to the creation of similar-outline nonsense character string data and a GUI (Graphical User Interface) therefor.

For example, the character recognition system 1 has a processor 11, an input apparatus 12, an output apparatus 13, a main storage apparatus 10, an auxiliary storage apparatus 14, and a communication interface unit 15. Each piece of hardware is coupled to one another via an internal bus or the like. While FIG. 2 shows only one of each piece of hardware, there may be two or more of each piece of hardware. A type of network to be coupled is not limited. Transmission/reception or processing of data may be shared with another computer or another storage apparatus via a network coupling or a direct coupling.

The processor 11 executes computer programs 100 to 105 that are stored in the main storage apparatus 10. Hereinafter, a computer program will be abbreviated as a program. A specific function is realized as the processor 11 as the “data processing unit” executes processing in accordance with a program. In the following description, describing processing with a program as a subject indicates that the processor 11 is executing the program.

The input apparatus 12 is an apparatus to be used by an operator (who may also be referred to as a system administrator or a user) to input information to the character recognition system 1. For example, the input apparatus 12 includes a device for operating a computer such as a keyboard, a mouse, or a touch panel. The input apparatus 12 includes a device for acquiring image data such as a scanner, a digital camera, or a smart phone.

The output apparatus 13 is an apparatus for providing the operator with information. The output apparatus 13 outputs an input screen, a processing result, and the like of data. For example, the output apparatus 13 includes a touch panel, a display, or a printer.

The main storage apparatus 10 as the “storage unit” stores programs to be executed by the processor 11 and information to be used by the programs. The main storage apparatus 10 includes a work area to be temporarily used by the programs. As the main storage apparatus 10, for example, a memory is conceivable.

For example, the main storage apparatus 10 stores a layout analysis program 100, a character recognition program 101, a similar-outline nonsense character string data collation program 102, a certainty factor calculation program 103, a character string and certainty factor output program 104, and a similar-outline nonsense character string registration program 105.

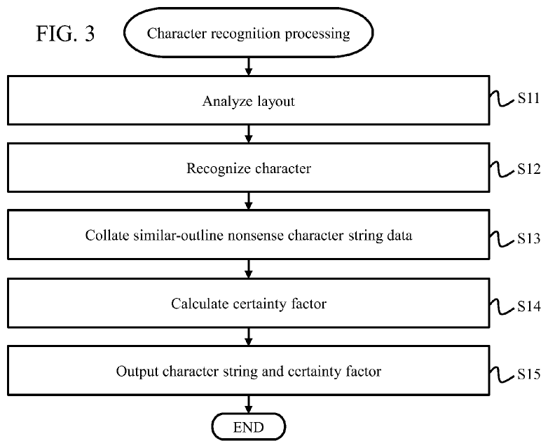

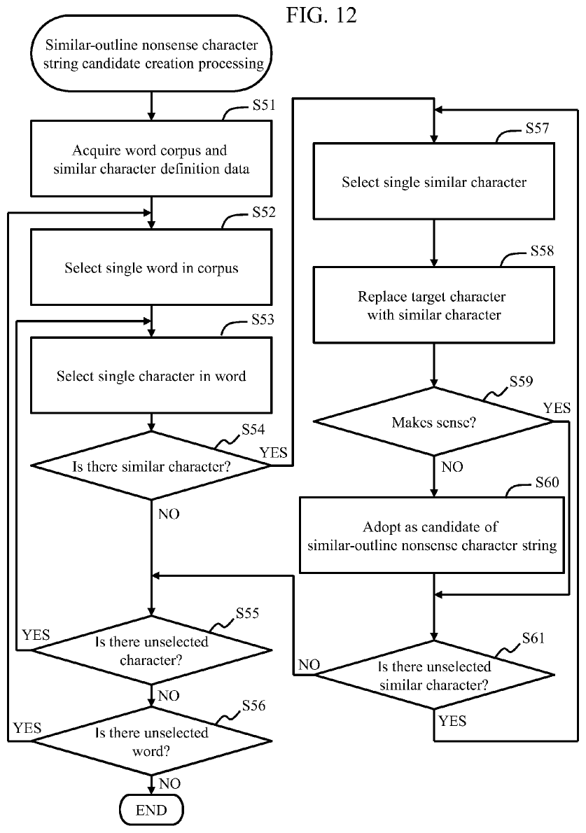

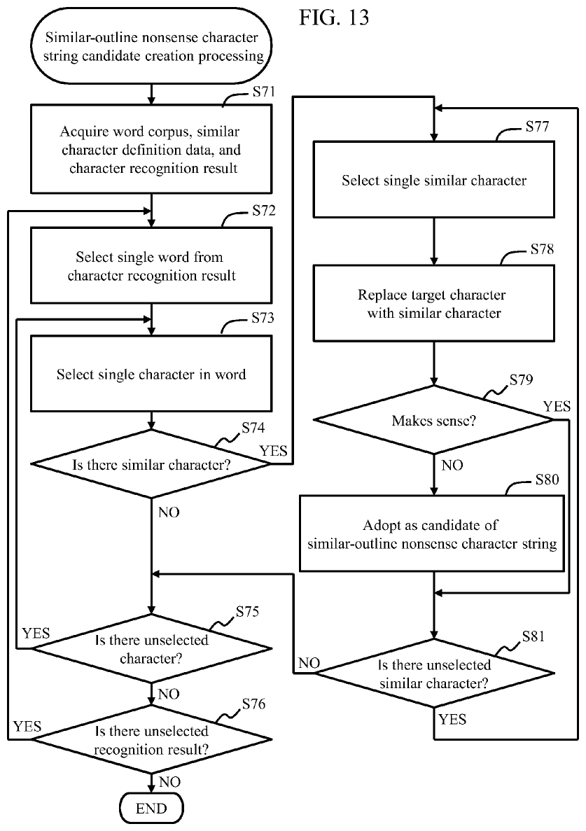

The programs 100 to 104 respectively correspond to steps of processing from steps S11 to S15 in FIG. 3 to be described later. The program 105 corresponds to processing of FIG. 12 and processing of FIG. 13 to be described later.

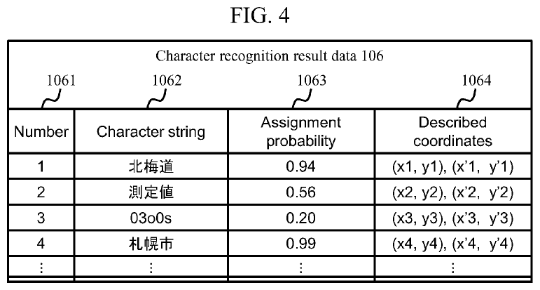

Furthermore, the main storage apparatus 10 stores, for example, character recognition result data 106, similar-outline nonsense character string data 107, the word corpus 108, and similar character definition data 109. Details of the character recognition result data 106, the similar-outline nonsense character string data 107, the word corpus 108, and the similar character definition data 109 will be described later with reference to FIGS. 4, 5, 10, and 11.

Details of processing of each module to be executed by the main storage apparatus 10 and information to be stored in the main storage apparatus 10 will be described when referring to FIG. 3 and thereafter.

A correspondence between FIG. 1 and FIG. 2 will now be described. The character recognizing unit F11 corresponds to the character recognition program 101. The recognition result confirming unit F12 corresponds to the similar-outline nonsense character string data collation program 102. The similar-outline nonsense character string managing unit F13 corresponds to the similar-outline nonsense character string data collation program 102, the similar-outline nonsense character string data 107, and the main storage apparatus 10. The character string correcting unit F14 and the certainty factor correcting unit F15 correspond to the character string and certainty factor output program 104. The similar-outline nonsense character string registering unit F16 and the registration candidate character string generating unit F17 correspond to the similar-outline nonsense character string registration program 105.

The main storage apparatus 10 need only realize a necessary part of modules and need not store programs and information for realizing all modules.

The auxiliary storage apparatus 14 permanently stores data. Conceivable examples of the auxiliary storage apparatus 14 include an HDD (Hard Disk Drive) and an SSD (Solid State Drive). It should be noted that the programs and information stored in the main storage apparatus 10 may be stored in the auxiliary storage apparatus 14. In this case, the processor 11 reads out programs and information from the auxiliary storage apparatus 14 and loads the programs and information to the main storage apparatus 10. The “storage unit” may be constituted by the main storage apparatus 10 or may be constituted by the main storage apparatus 10 and the auxiliary storage apparatus 14.

The communication interface unit 15 is coupled to a communication network CN. The character recognition system 1 can transmit and receive data to and from another computer or another storage apparatus via the communication interface unit 15 and the communication network CN.

FIG. 2 shows a computer terminal 2 as an example of another computer. For example, as known as a so-called cloud information processing service, the operator can use a character recognition processing service provided by the character recognition system 1 by operating the terminal 2. Alternatively, as known as an on-premise information processing service, the operator can utilize the character recognition system 1 by using the input apparatus 12 and the output apparatus 13.

A storage medium MM can be coupled to the character recognition system 1 either directly or via the communication network CN. The storage medium MM is, for example, an SSD. At least a part of the programs or data that are stored in the storage medium MM can be transferred to and stored in the character recognition system 1. At least a part of the programs or data that are stored in the character recognition system 1 can also be transferred to and stored in the storage medium MM.

An overview of character recognition processing by the character recognition system 1 will be described with reference to FIG. 3. The character recognition system 1 performs, with respect to input image data (the image data D1 shown in FIG. 1), layout analysis processing by the layout analysis program 100 (S11).

The layout analysis processing is processing that is performed as pre-processing of character recognition. For example, as the layout analysis processing, conceivably, an input image is converted into a black-and-white binary image, coupled black pixel components are extracted, and ruled lines, character rows, table areas, and the like are extracted from the image.

The input image to be a processing target of step S11 may be acquired from the input apparatus 12 or acquired from the auxiliary storage apparatus 14, the external terminal 2, the storage medium MM, or the like. The character recognition system 1 can also receive image data that is a processing target from the communication network CN via the communication interface unit 15.

The character recognition system 1 performs character recognition processing by the character recognition program 101 (S12). The character recognition processing refers to processing for character type discrimination that is performed with respect to the character string extracted in step S12. For example, in character recognition processing, a character type is discriminated by extracting a directional feature from an image of a character string and performing a nearest neighbor search inside a character recognition dictionary using the directional feature.

A probability of assignment to the discriminated character type is simultaneously acquired with the character type discrimination. The character recognition result data 106 is output as a processing result of step S12. The character recognition result data 106 will be described later with reference to FIG. 4.

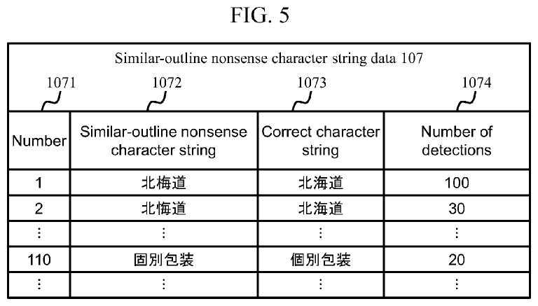

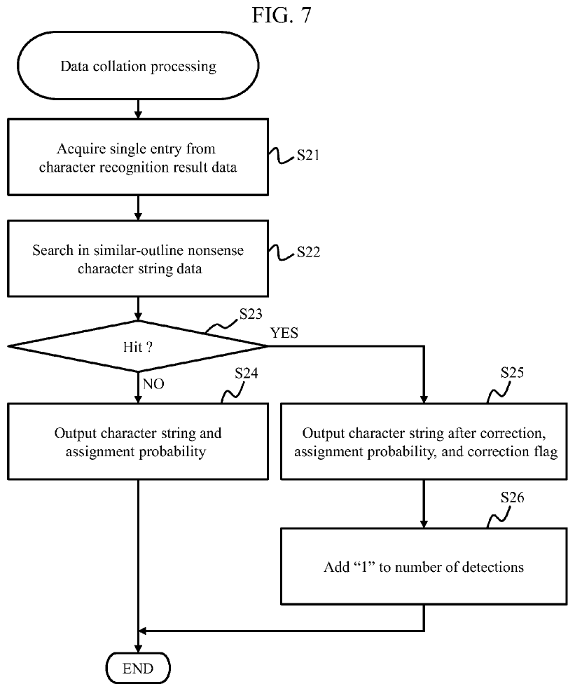

The character recognition system 1 performs similar-outline nonsense character string data collation processing by the similar-outline nonsense character string data collation program 102 (S13). In the similar-outline nonsense character string data collation processing, the character recognition result data 106 and the similar-outline nonsense character string data 107 are collated with each other and a similar-outline nonsense character string that matches a result of the character recognition is detected. The similar-outline nonsense character string data 107 will be described later with reference to FIG. 5. Details of the processing performed in step S13 will be described later with reference to FIG. 7.

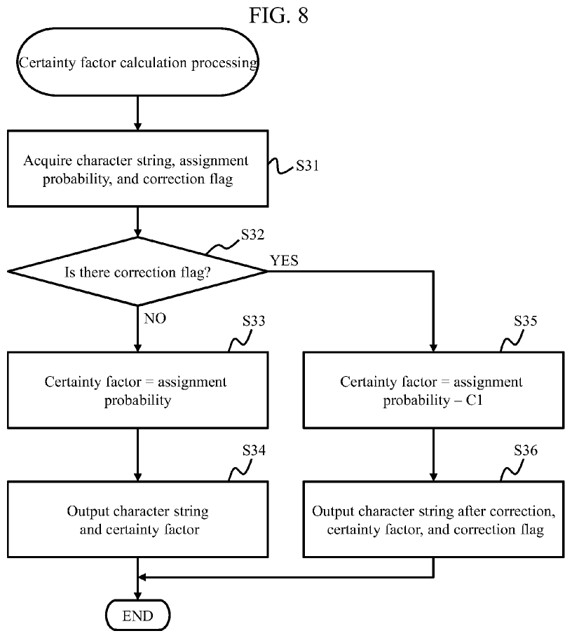

The character recognition system 1 performs certainty factor calculation processing by the certainty factor calculation program 103 (S14). In the certainty factor calculation processing, a certainty factor during character recognition is calculated based on probability of assignment to the character type acquired in step S12 and the similar-outline nonsense character string detected in step S13. Details of the processing performed in step S14 will be described later with reference to FIG. 8. It should be noted that arbitrary linguistic processing and a certainty factor calculation may be additionally performed before or after step S13 and step S14.

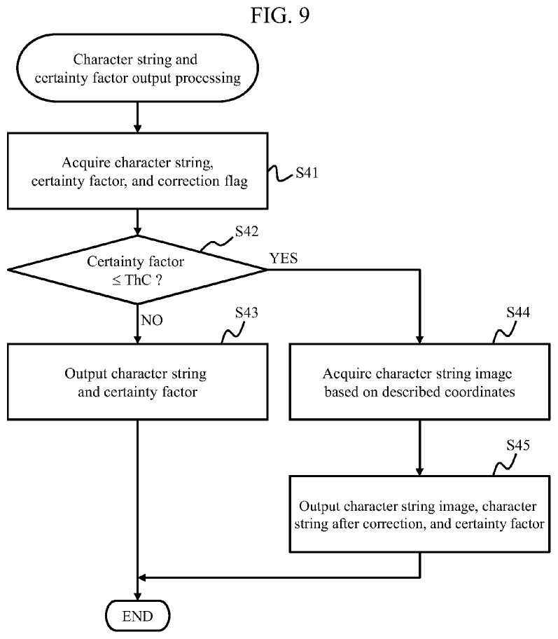

The character recognition system 1 performs character string and certainty factor output processing by the character string and certainty factor output program 104 (S15). In the character string and certainty factor output processing, the collated character recognition result (the similar-outline nonsense character string that matches a result of the character recognition) acquired in step S13 and the certainty factor acquired in S14 are output. Details of the processing performed in step S15 will be described later with reference to FIG. 9. A GUI may be used to check a collated character recognition result.

FIG. 4 is an example of the character recognition result data 106. The character recognition result data 106 has, as an entry, a result of the character type discrimination acquired by the character recognition processing in step S12 having been organized for each character string. For example, the character recognition result data 106 includes an object number 1061, a character string 1062, an assignment probability 1063, and described coordinates 1064.

The object number 1061 stores a number for uniquely identifying each object. The character string 1062 stores the character string acquired by the character recognition processing. The assignment probability 1063 stores a probability of assignment to each character type of the character string acquired by the character recognition processing. Generally, as the assignment probability of a character string, in the case of a single character, the assignment probability is that of a single character, and in the case of a plurality of characters, the assignment probability of a single character is integrated by the number of characters. The described coordinates 1064 store coordinates in an input document image where an entry is described.

FIG. 5 shows an example of the similar-outline nonsense character string data 107. The similar-outline nonsense character string data 107 has a similar-outline nonsense character string and a correct character string that are paired together as an entry. For example, the similar-outline nonsense character string data includes an object number 1071, a similar-outline nonsense character string 1072, a correct character string 1073, and number of detections 1074.

The object number 1071 stores a number for uniquely identifying each object. The similar-outline nonsense character string 1072 stores a character string which is likely to be misread and which does not make linguistic sense or, in other words, a similar-outline nonsense character string.

The correct character string 1073 stores a correct character string that corresponds to the similar-outline nonsense character string 1072. The number of detections 1074 stores a total number of times the similar-outline nonsense character string had been detected during character recognition. A method of creating the similar-outline nonsense character string data 107 will be described later with reference to FIGS. 12 and 13.

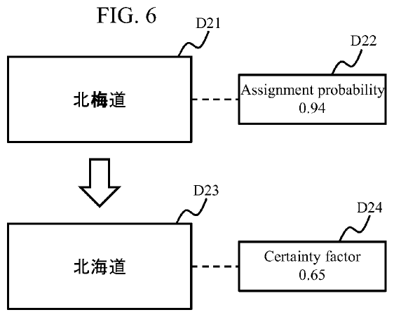

FIG. 6 is a schematic diagram showing a result of character recognition and a result of certainty factor calculation processing (S15). A character recognition result D21 is an example of a result of recognizing a certain character string image and represents an erroneous recognition as “ [symbol] ” of a character string originally described “ [symbol] ”. An assignment probability D22 is an assignment probability with respect to the character recognition result D21 and is “0.94”. These results correspond to a first entry of the character recognition result data 106 shown in FIG. 4. The character recognition result D21 is collated with the similar-outline nonsense character string data 107 shown in FIG. 5 to correct the character recognition result and calculate a certainty factor. Accordingly, the character recognition system 1 acquires a similar-outline nonsense character string collation and correction result D23 and a certainty factor D24 thereof.

If the character recognition system 1 is not provided with means of performing character recognition result correction and certainty factor calculation based on a collation with the similar-outline nonsense character string data 107, a recognition error or an erroneous description in a document that reads “ [symbol] ” ends up being determined to have a high certainty factor and is automatically converted into electronic data. In contrast, the character recognition system 1 compares a result of character recognition with a similar-outline nonsense character string, corrects a character recognition result that matches the similar-outline nonsense character string to a correct character string and, at the same time, lowers the certainty factor with respect to the erroneous character recognition. Therefore, the character recognition system 1 is capable of realizing an improvement in accuracy of character recognition and a direct increase in a correlation between a certainty factor and whether character recognition is correct or incorrect.

FIG. 7 is a flow chart showing similar-outline nonsense character string data collation processing. The character recognition system 1 acquires a single entry from the character recognition result data 106 (S21) and searches for a character string of the entry acquired in step S21 in the similar-outline nonsense character string data 107 (S22).

The character recognition system 1 determines whether or not the character recognition result data acquired in step S21 is present in the similar-outline nonsense character string data 107 (S23).

When a similar-outline nonsense character string data that corresponds to the character recognition result data is not present (S23: NO), the character recognition system 1 causes the recognition result character string 1062 prior to correction and the assignment probability 1063 to be output (S24).

On the other hand, when a similar-outline nonsense character string data that corresponds to the character recognition result data is present (S23: YES), the character recognition system 1 causes the recognition result character string 1062 and the assignment probability 1063 after correction to a correct character to be output (S25).

The character recognition system 1 adds “1” to the number of detections 1074 of the entry acquired in step S21 (S26).

FIG. 8 is a flow chart showing certainty factor calculation processing. The character recognition system 1 acquires the character string and the assignment probability output in step S24 or acquires the character string after correction and the assignment probability output in step S25 and a correction flag (S31).

The character recognition system 1 determines whether or not there is a correction flag in the data acquired in step S31 (S32). When there is no correction flag (S32: NO), the character recognition system 1 substitutes the assignment probability acquired in step S31 into the certainty factor of character recognition (S33). The character recognition system 1 outputs the original character string (the character string prior to correction) and the certainty factor (=assignment probability) having been output as a result of character recognition (S34).

On the other hand, when there is a correction flag in the data acquired in step S31 (S32: YES), the character recognition system 1 substitutes a value obtained by subtracting a predetermined number C1 from the assignment probability (certainty factor=assignment probability−C1) into the certainty factor of character recognition (S35). In this case, the predetermined number C1 is an arbitrary numerical value that is determined by, for example, an administrator of the character recognition system 1. It should be noted that, in step S35, as a penalty for an erroneous result of character recognition, the certainty factor of the character recognition need only be lowered. Therefore, instead of a method of subtracting the predetermined number C1 from the assignment probability, a method of multiplying the assignment probability by a value of “1” or less may be used. Other calculation methods can also be adopted.

The character recognition system 1 outputs the character string (the character string after correction) having been corrected with a correct character, a certainty factor, and a correction flag (S36).

FIG. 9 is a flow chart showing character string and certainty factor output processing. The character recognition system 1 acquires the character string and the certainty factor output in step S34 or acquires the character string after correction, the certainty factor, and the correction flag output in step S36 (S41).

The character recognition system 1 determines whether the acquired certainty factor is equal to or smaller than a prescribed threshold ThC (S42). The threshold ThC is an arbitrary numerical value that can be determined by, for example, the administrator of the character recognition system 1.

When the certainty factor is larger than the threshold ThC (S42: NO), the character recognition system 1 outputs an uncorrected character string and a certainty factor (S43). When the certainty factor is equal to or smaller than the threshold ThC (S42: YES), based on the described coordinates 1064, the character recognition system 1 cuts out and acquires an image of a character string from the image data having been input to character recognition processing (S44).

The character recognition system 1 outputs the character string image having been cut out in step S44, a character string after correction, and a certainty factor (S45).

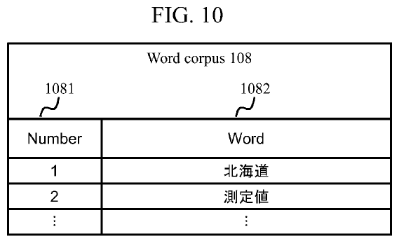

FIG. 10 is a diagram showing an example of the word corpus 108. For example, a single entry of the word corpus 108 includes an object number 1081 and a word 1082.

The object number 1081 stores a number for uniquely identifying each object. The word 1082 stores a word that actually exists.

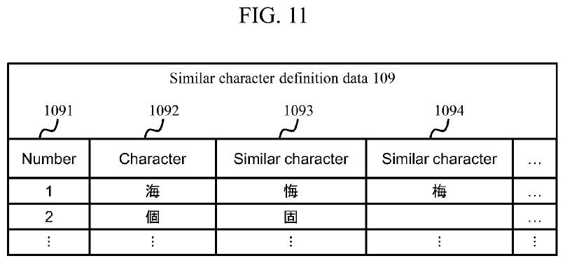

FIG. 11 is a diagram showing an example of the similar character definition data 109. For example, a single entry of the similar character definition data 109 includes an object number 1091, a character 1092, a similar character 1093, and a similar character 1094.

The object number 1091 stores a number for uniquely identifying each object. The character 1092 stores a single character type. The similar character 1093 stores a single character type that is similar to the character 1092. The similar character 1094 stores a single character type which is similar to the character 1092 but which differs from the similar character 1093.

There may be two or more similar characters. The character 1092 is also a similar character that is similar to the similar character 1093 and the similar character 1094.

FIG. 12 is a flow chart showing an example of processing for creating a candidate of a similar-outline nonsense character string. In the processing shown in FIG. 12, a candidate of a similar-outline nonsense character string is automatically generated using the word corpus 108.

The character recognition system 1 acquires the word corpus 108 and the similar character definition data 109 (S51), selects a single word from the acquired word corpus 108 (S52), and further selects a single character from the selected word (S53).

The character recognition system 1 branches subsequent processing based on a presence or an absence of a similar character with respect to the character selected in step S53 (S54). When a similar character is present (S54: YES), the character recognition system 1 advances to step S57, but when a similar character is not present (S54: NO), the character recognition system 1 advances to step S55.

The character recognition system 1 branches subsequent processing based on a presence or an absence of a not yet selected character among the selected word (S55). When an unselected character is present (S55: YES), the character recognition system 1 returns to step S53, but when an unselected character is not present (S55: NO), the character recognition system 1 advances to step S56.

The character recognition system 1 branches subsequent processing based on a presence or an absence of a not yet selected character in the word corpus 108 (S56). When an unselected character is present, the character recognition system 1 returns to step S52, but when an unselected character is not present, the character recognition system 1 ends the processing.

In step S57, the character recognition system 1 selects a similar character in a target entry of the similar character definition data 109. In the target character string, the character recognition system 1 replaces the character selected in step S53 with the similar character selected in step S57 (S58).

The character recognition system 1 branches subsequent processing based on whether or not the character string obtained by replacing a single character with a similar character is present in the word corpus 108 or, in other words, whether or not the character string obtained by replacing the single character with the similar character makes sense (S59).

When the character string obtained by replacing the single character with the similar character makes sense (S59: YES) or, in other words, when the character string linguistically holds true, the character recognition system 1 advances to step S61. In contrast, when the character string obtained by replacing the single character with the similar character does not make sense (S59: NO), the character recognition system 1 determines that the character string does not linguistically hold true and advances to step S60.

The character recognition system 1 adopts the character string obtained by replacing the single character with the similar character as a candidate of a similar-outline nonsense character string (S60).

The character recognition system 1 branches subsequent processing based on whether or not there is a not yet selected similar character in the target entry of the similar character definition data 109 (S61). When an unselected character is present (S61: YES), the character recognition system 1 returns to step S57, but when an unselected character is not present (S61: NO), the character recognition system 1 returns to step S55.

FIG. 13 is a flow chart showing an example of other processing for creating a candidate of a similar-outline nonsense character string. In the processing shown in FIG. 13, a candidate of a similar-outline nonsense character string is automatically generated from a result of character recognition processing. The present processing differs from the processing described with reference to FIG. 12 in steps S71, S72, and S76 to be described below.

The character recognition system 1 acquires the word corpus 108, the similar character definition data 109, and the character recognition result data 106 (S71), and selects a single word from the acquired character recognition result data 106 (S72). The character recognition system 1 further selects a single character from the selected word (S73).

The character recognition system 1 branches subsequent processing based on a presence or an absence of a similar character with respect to the character selected in step S73 (S74). When a similar character is present (S74: YES), the character recognition system 1 advances to step S77, but when a similar character is not present (S74: NO), the character recognition system 1 advances to step S75.

The character recognition system 1 branches subsequent processing based on a presence or an absence of a not yet selected character among the selected word (S75). When an unselected character is present (S75: YES), the character recognition system 1 returns to step S73, but when an unselected character is not present (S75: NO), the character recognition system 1 advances to step S76.

The character recognition system 1 branches subsequent processing based on a presence or an absence of a not yet selected word in the character recognition result data 106 (S76). When an unselected word is present (S76: YES), the character recognition system 1 returns to step S72, but when an unselected word is not present (S76: NO), the character recognition system 1 ends the processing.

In step S77, the character recognition system 1 selects a similar character in a target entry of the similar character definition data 109. In the target character string, the character recognition system 1 replaces the character selected in step S73 with the similar character selected in step S77 (S78).

The character recognition system 1 branches subsequent processing based on whether or not the character string obtained by replacing a single character with a similar character is present in the word corpus 108 or, in other words, whether or not the character string obtained by replacing the single character with the similar character makes sense (S79).

When the character string obtained by replacing the single character with the similar character makes sense (S79: YES) or, in other words, when the character string linguistically holds true, the character recognition system 1 advances to step S81. In contrast, when the character string obtained by replacing the single character with the similar character does not make sense (S79: NO), the character recognition system 1 determines that the character string does not linguistically hold true and advances to step S80.

The character recognition system 1 adopts the character string obtained by replacing the single character with the similar character as a candidate of a similar-outline nonsense character string (S80).

The character recognition system 1 branches subsequent processing based on whether or not there is a not yet selected similar character in the target entry of the similar character definition data 109 (S81). When an unselected character is present (S81: YES), the character recognition system 1 returns to step S77, but when an unselected character is not present (S81: NO), the character recognition system 1 returns to step S75.

As described above, in the character recognition system 1 according to the present embodiment, a candidate of a similar-outline nonsense character string can be automatically generated from the word corpus 108 or a candidate of a similar-outline nonsense character string can be generated from a result of character recognition processing. The character recognition system 1 can present the system administrator with candidates of a similar-outline nonsense character string from a GUI to be described later and register a candidate selected by the system administrator as a similar-outline nonsense character string. Alternatively, the character recognition system 1 can automatically register a candidate of a similar-outline nonsense character string as a new similar-outline nonsense character string. It should be noted that the system administrator can also manually register a new similar-outline nonsense character string in the character recognition system 1.

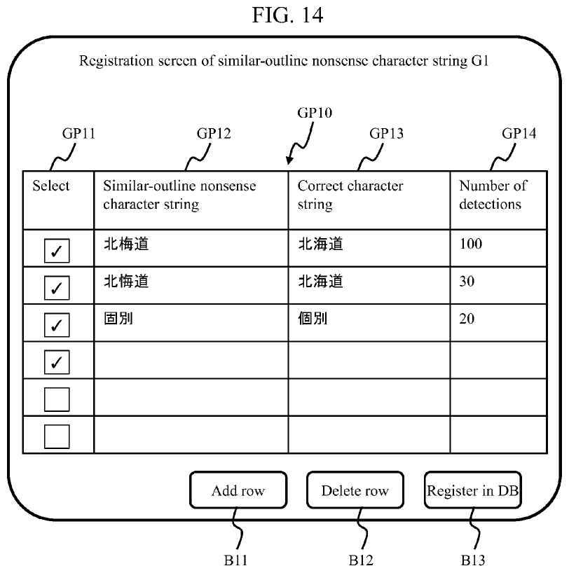

FIG. 14 shows an example of a screen G1 for registering, in the similar-outline nonsense character string data 107, a candidate of a similar-outline nonsense character string having been created in the similar-outline nonsense character string candidate creation processing shown in FIGS. 12 and 13.

For example, the registration screen G1 includes a candidate list GP10, a row addition button B11, a row deletion button B12, and a database registration button B13.

The candidate list GP10 shares a common configuration with the similar-outline nonsense character string data 107 shown in FIG. 5 and includes a selection field GP11, a similar-outline nonsense character string field GP12, a correct character string field GP13, and a number of detections field GP14.

A candidate created by the similar-outline nonsense character string candidate creation processing and a correct character string thereof are input to the candidate list GP10 by default. On the screen (GUI) G1, a user (for example, an operator or a system administrator) can also respectively input an arbitrary character string to the similar-outline nonsense character string field GP12 and the correct character string field GP13. The selection field GP11 is checked when row addition, row deletion, or data registration is to be performed.

In addition to the above, for example, a function for causing the candidate list GP10 to be scrolled or a function for displaying identification information of a user having added each similar-outline nonsense character string such as a time and date of the addition of the similar-outline nonsense character string may be provided.

According to the present embodiment that is configured as described above, since character recognition processing can be executed using a similar-outline nonsense character string, an improvement in accuracy of character recognition and a direct increase in a correlation between a certainty factor and whether character recognition is correct or incorrect can be realized.

In addition, according to the present embodiment, since a user is presented with the number of detections of the similar-outline nonsense character string that matches a character recognition result, the user can readily comprehend characters that are likely to be erroneously recognized and usability of the user improves.

Furthermore, according to the present embodiment, since a similar-outline nonsense character string can be registered in the character recognition system 1 using at least any of the methods involving the word corpus 108 and a result of character recognition processing, usability of the user improves.

### Second Embodiment

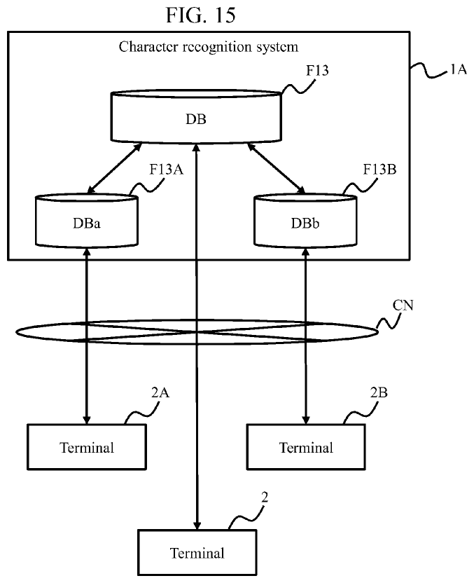

A second embodiment now will be described with reference to FIG. 15. A character recognition system LA according to the present embodiment respectively prepares dedicated similar-outline nonsense character string managing units F13A and F13B for customer-specific terminals 2A and 2B.

The terminal 2A belonging to a certain organization utilizes the dedicated similar-outline nonsense character string managing unit F13A to receive a character recognition processing service. The terminal 2B belonging to another organization utilizes the other dedicated similar-outline nonsense character string managing unit F13B to receive a character recognition processing service.

The similar-outline nonsense character string managing unit 2 has contents of the dedicated similar-outline nonsense character string managing units 2A and 2B. The terminal 2 utilizes the similar-outline nonsense character string managing unit 2 to receive a character recognition processing service.

The present embodiment configured in this manner produces similar operational advantages to the first embodiment. Furthermore, in the present embodiment, since the dedicated similar-outline nonsense character string managing unit F13A or F13B is prepared for each organization, sizes of the similar-outline nonsense character string managing units F13A and F13B can be reduced and the time required to search for a similar-outline nonsense character string can be reduced.

The components of the embodiments presented above have been described in detail to provide a clear understanding of the present invention, and the present invention is not necessarily limited to embodiments that includes all of the components described above. Furthermore, a part of the components of the respective embodiments may be added to, deleted from, or replaced with other components.

Moreover, the respective components, functions, processing units, processing means, and the like described above may be partially or entirely realized by hardware by, for example, designing with integrated circuits or the like. In addition, the present invention can also be realized by a program code of software that realizes the functions of the embodiments. In this case, a computer is provided with a storage medium on which the program code is recorded, and a processor included in the computer reads the program code stored in the storage medium. In this case, the program code itself that is read from the storage medium is to realize the functions of the embodiments described above, and the program code itself and the storage medium storing the program code are to constitute the present invention. As the storage medium for supplying such a program code, for example, a flexible disk, a CD-ROM, a DVD-ROM, a hard disk, an SSD (Solid State Drive), an optical disk, a magneto-optical disk, a CD-R, a magnetic tape, a nonvolatile memory card, or a ROM is used.

In addition, the program code that realizes the functions described in the present embodiment can be implemented in a wide range of programs or scripting languages such as on assembler, C/C++, perl, Shell, PHP, and Java (registered trademark).

Furthermore, by distributing, via a network, the program code of software that realizes functions of the embodiments, the program code may be stored in storage means such as a hard disk or a memory of a computer or a storage medium such as a CD-RW or a CD-R, and a processor included in the computer may read the program code stored in the storage means or the storage medium and execute the program code.

In the embodiments described above, the control lines and information lines are those considered necessary for purposes of illustration and do not necessarily represent all control lines and information lines as far as a product is concerned. All of the components may be coupled to each other.

1. A character recognition system converting image data of a character string into a character code, the character recognition system comprising:
a data processing unit; and
a storage unit configured to be used by the data processing unit, wherein
the storage unit is configured to store a similar-outline nonsense character string that has an outline similar to that of an ordinary character string but does not make sense, and
the data processing unit is configured to perform character recognition processing using the similar-outline nonsense character string that is stored in the storage unit.

2. The character recognition system according to claim 1, wherein the storage unit is configured to store the similar-outline nonsense character string and a correct character string that corresponds to the similar-outline nonsense character string.

3. The character recognition system according to claim 2, wherein the data processing unit is configured to correct, when a similar-outline nonsense character string matching a recognition result character string that is a result of character recognition is stored in the storage unit, the recognition result character string to the corresponding correct character string.

4. The character recognition system according to claim 3, wherein the data processing unit is configured to lower, when a similar-outline nonsense character string matching the recognition result character string is stored in the storage unit, a certainty factor of the recognition result character string.

5. The character recognition system according to claim 4, wherein the data processing unit is configured to store, when the recognition result character string matches a similar-outline nonsense character string that is stored in the storage unit, the number of times of the matching.

6. The character recognition system according claim 1, wherein the data processing unit further comprises a registering unit configured to register a similar-outline nonsense character string in the storage unit.

7. The character recognition system according to claim 6, wherein the registering unit is configured to generate a candidate of a similar-outline nonsense character string on the basis of a word in a word corpus.

8. The character recognition system according to claim 7, wherein the registering unit is configured to adopt, when a post-replacement character string generated by replacing an arbitrary character of an arbitrary word, selected from the word corpus, with a similar character having a similar outline does not make sense, the post-replacement character string as a candidate of a similar-outline nonsense character string.

9. The character recognition system according to claim 6, wherein the registering unit is configured to generate a candidate of a similar-outline nonsense character string on the basis of a result of erroneous character recognition by the character recognition processing.

10. The character recognition system according to claim 9, wherein the registering unit is configured to adopt, when a result of erroneous character recognition by the character recognition processing does not make sense, adopt a result of the character recognition as a candidate of a similar-outline nonsense character string.

11. A character recognition method of causing a computer to convert image data of a character string into a character code, with the computer including a data processing unit, and a storage unit to be used by the data processing unit, and the storage unit storing a similar-outline nonsense character string that has an outline similar to that of an ordinary character string but does not make sense, the method comprising performing by the data processing unit character recognition processing using the similar-outline nonsense character string that is stored in the storage unit.

12. The character recognition method according to claim 11, wherein
the storage unit stores the similar-outline nonsense character string and a correct character string that corresponds to the similar-outline nonsense character string, and
the data processing unit
corrects, when a similar-outline nonsense character string matching a recognition result character string that is a result of character recognition is stored in the storage unit, the recognition result character string to the corresponding correct character string, and
lowers, when a similar-outline nonsense character string matching the recognition result character string is stored in the storage unit, a certainty factor of the recognition result character string.

13. A computer program causing a computer to function as a character recognition system converting image data of a character string into a character code, with the computer including a data processing unit, and a storage unit to be used by the data processing unit, and with the storage unit storing a similar-outline nonsense character string that has an outline similar to that of an ordinary character string but does not make sense,
the program causing the data processing unit to perform character recognition processing using the similar-outline nonsense character string that is stored in the storage unit.
